(19) United States
(12) Patent Application Publication
(10) Pub. No.: US 2014/0279700 A1
(43) Pub. Date: Sep. 18, 2014

(54) PAY PLAN SYSTEM AND METHOD FOR MITIGATING RISK AND IMPROVING EMPLOYEE COMPENSATION

(71) Applicant: THOMAS WAYNE COOK, Midland, TX (US)

(72) Inventor: THOMAS WAYNE COOK, Midland, TX (US)

(21) Appl. No.: 14/215,390

(22) Filed: Mar. 17, 2014

Related U.S. Application Data
(60) Provisional application No. 61/802,340, filed on Mar. 15, 2013.

(51) Int. Cl. G06Q 10/06

(52) U.S. Cl. CPC G06Q 10/0635; G06Q 40/06
USPC 705/36 R; 705/320

(57) ABSTRACT

Some embodiments of the invention include a novel pay plan system and method for mitigating risk and improving employee compensation. In some embodiments, the method converts a single pay raise into an employer contribution to a 401a Plan, thereby causing the effect of this pay raise to become significantly larger in its monetary amount. In some embodiments, the method transforms 401a matching plans to fully serve public schools by combining both a retirement supplement plan and a compensation enhancement plan into a single plan.

### CLAIM OF BENEFIT TO PRIOR APPLICATION

This application claims benefit to U.S. Provisional Patent Application 61/802,340, entitled “Pay Plan System And Method For Mitigating Risk And Improving Employee Compensation,” filed Mar. 15, 2013. The U.S. Provisional Patent Application 61/802,340 is incorporated herein by reference.

### BACKGROUND

Embodiments of the invention described in this specification relate generally to compensation plans and systems, and more particularly, to methods of providing effective employee compensation plans and systems that mitigate risk and improve overall compensation outcomes.

Compensation plans for public school teachers, and in most other public-employer groups, typically involve a two-step income calculation. Fir the employee is ranked according to their credentials, such as degree attained and the number of years of experience the employee brings to their job. Second, once the initial pay rate is established, employees typically will receive an annual pay increase in the form of a regular step increase.

The two-step income calculation was developed to provide a structured, non-political, non-biased method to fairly compensate all employees of a similar work assignment. The mechanisms of the income calculation are a response to unfair treatment of teachers based on age, race, and favoritism in years past. In this sense, the two-step income calculation represents advancement in the treatment of public school teachers. However, despite its benefits, the two-step income calculation may fail to ensure public teachers feel appreciated for their work.

Where compensation to teachers follows a ridged schedule, the teachers are more likely to feel their income is merely what they are due. This sense of entitlement may even apply to their regular step increase, typically applied annually before the start of a new school year. Lacking a feeling of recognition, teacher morale may fall and motivation to serve student may fall along with morale. Where employees feel unrecognized for individual contributions, this lowered morale often follows. In its current state, teacher pay-raises rarely, if ever, improve the morale of the teacher, and they rarely, if ever, have any real impact upon teachers financial condition.

A problem arises therefore, since the employer is bound to a two-step income calculation for the sake of fairness, meanwhile, the instrument ensuring fairness leads to lowered morale.

Further complicating the employer's ability to compensate a schoolteacher is the lack of financial resources in a school district. Even if an employer were allowed to pay teachers bonuses, they may lack the resources to do so. For example, in one Texas school district, the payroll expenses of the district exceeded 80% of the district's budget. When payroll expenses are this high, the employer's ability to increase compensation will conflict with the employer's non-payroll expenses such as utility bills and building projects.

Further compounding the problem, payroll overhead makes the effect of pay-raises less rewarding to employees; thus, a pay-raise provides less reward than a school district sets out to provide. For example, payroll overhead can be thought of as the combination of the employer's payroll costs plus the employee's payroll deductions. An employer's cost of every pay-raise is increased by attendant payroll costs such as an increase in social security taxes, workers compensation insurance, unemployment insurance and pension plans. The employee's net income is reduced by payroll deductions such as social security costs, income taxes and pension contributions.

Accordingly, it would be useful to have a pay plan system and method for mitigating risk and improving employee compensation.

### BRIEF DESCRIPTION

Some embodiments of the invention include a novel pay plan system and method for mitigating risk and improving employee compensation. In some embodiments, the method converts a single pay raise into an employer contribution to a 401a Plan, thereby causing the effect of this pay raise to become significantly larger in its monetary amount. In some embodiments, the method transforms 401a matching plans to fully serve public schools by combining both a retirement supplement plan and a compensation enhancement plan into a single plan.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1A conceptually illustrates a block diagram of a risk management and compensation improvement system in some embodiments.

FIG. 1B conceptually illustrates a block diagram of a pay plan module for a risk management and compensation improvement system in some embodiments.

FIG. 2A conceptually illustrates a current plan module with one or more user inputs, an input module, and a user data input repository in some embodiments.

FIG. 2B conceptually illustrates another current plan module with inputs for an employee background, added payroll costs, and home deductions flowing into an input module and then to a user data input repository in some embodiments.

FIG. 2C conceptually illustrates another current plan module with several example user inputs flowing into an input module and then to a user data input repository in some embodiments.

FIG. 3 conceptually illustrates an example of a computer display with a graphical user interface (GUI) for receiving user inputs for an input module in some embodiments.

FIG. 4 conceptually illustrates a process performed by a pay plan module of a risk management and compensation improvement system in some embodiments.

FIG. 5 conceptually illustrates a computer display of a table that includes cost to employer calculations in some embodiments.

FIG. 6 conceptually illustrates a computer display of a table that includes value of raise calculations in some embodiments.

FIG. 7 conceptually illustrates a computer display of a cost vs. benefit table in some embodiments.

FIG. 8 conceptually illustrates a computer display of a cost vs. benefit chart in some embodiments.

FIG. 9 conceptually illustrates a computer display of a pay plan summary in some embodiments.

FIG. 10 conceptually illustrates a process for calculating and displaying plan value accumulation in a pay plan implementation of some embodiments.

FIG. 11 conceptually illustrates a computer display of a plan value accumulation table.

FIG. 12A conceptually illustrates a computer display of an example report card for a pay plan.

FIG. 12B conceptually illustrates a computer display of another example report card for a pay plan.

FIGS. 13A, 13B, 13C, and 13D conceptually illustrate a method for risk management and compensation improvement in some embodiments.

FIG. 14 conceptually illustrates an electronic system with which some embodiments of the invention are implemented.

### DETAILED DESCRIPTION

Described herein is a pay plan system and method for mitigating risk and improving employee compensation. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

As stated above, teacher pay-raises rarely, if ever, improve the morale of the teacher, and they rarely, if ever, have any real impact upon the teacher's financial condition. Addressing these problems, some embodiments of the invention include a novel pay plan system and method for mitigating risk and improving employee compensation. In some embodiments, the method converts a single pay raise into an employer contribution to a 401a Plan, thereby causing the effect of this pay raise to become significantly larger in its monetary amount. The monetary amount is able to become larger than the monetary amount the teacher would see in a pay check because the employer avoids several additional costs that are associated with salaries. For example, the employer avoids mandatory social security (SS) contributions, workers compensation payments, unemployment compensation, teacher retirement plan contributions, etc. In this way, the entire raise is deposited directly into an account for the teacher's future use.

FIG. 1A conceptually illustrates a block diagram of a risk management and compensation improvement system 100 in some embodiments. As show in this figure, the risk management and compensation improvement system 100 includes an input module 101, a pay plan module 102, and an output module 103. In this example, each of the input module 101 and the output module 103 are shown for illustrative purposes only. In some embodiments, the input module 101 is part of the pay plan module 102. In some embodiments, the output module 103 is part of the pay plan module. In some embodiments, both the input module 101 and the output module 103 are part of the pay plan module 102. The risk management and compensation improvement system 100 may be used to provide a risk management plan and employee compensation improvement to a user according to one or more parameters. Examples of such a user include school district employees (such as teachers, administrators, and maintenance personnel), employees of governmental departments, and/or employees of not-for-profit organizations.

To further enhance this plan as a morale booster, each pay check of a teacher may have a printed pay stub featuring calculated amounts and a comparison between the amount of a taken pay raise and the amount of a plan-contributed pay raise. For example, a teacher's pay stub may demonstrate the comparison by printing a first amount stating, “Had you taken the money as a pay-raise this pay check would be larger by this amount: $_” (with a number value printed in place of the underlining), and printing a second amount stating, “But instead of a raise, the Employer makes contributions to the 401a Plan for you, your 401a account received this amount of money: $_” (with a different/higher number value printed in place of the underlining). In some embodiments, a software application that runs on a computing device performs calculations for each of the first and second amounts in order to provide the teacher with the comparison on the pay stub.

FIG. 1B conceptually illustrates a block diagram of a pay plan module for a risk management and compensation improvement system in some embodiments. As shown in this figure, the pay plan module 102 includes a current plan module 102a, a pay plan implementation module 102b, and a pay plan maintenance module 102c. In different embodiments, each of the current plan module 102a, the pay plan implementation module 102b, and the pay plan maintenance module 102c may include different implementation details.

In at least one embodiment, the pay plan implementation module 102b comprises an employee matching module 102b and the pay plan maintenance module 102c comprises a morale boosting module 102c.

In another embodiment, the current plan module 102a comprises a system and method for establishing the limitations of current compensation methods. The system and method for establishing the limitations of current compensation methods in some embodiments includes calculating the effect of an employee's raise on an annual basis. In some embodiments, the system and method for establishing the limitation of current compensation methods includes calculating an employer's cost for anticipated raises.

In some embodiments, the pay plan implementation module 102b includes an employee matching module comprising a system and method for displaying the value of placing monies in an employee matching program rather than taking a standard pay raise. In another embodiment, the pay plan implementation module 102b comprises a system and method illustrating stages of a financial strategy. In some embodiments, the stages of the financial strategy comprise a three-stage plan. In other embodiments, more than three stages or less than three stages are included in the financial plan.

In some embodiments, the pay plan maintenance module 102c comprises a system and method for illustrating a progress report regarding their accumulated funds under risk management and compensation improvement system and method 100. In at least one embodiment, the pay plan maintenance module 102c comprises a system and method for illustrating the user's progress during the various stages of the financial strategy. For instance, the system and method may display the user's progress at each of the three stages when the pay plan maintenance module 102c implements a three-stage financial strategy. Furthermore, in at least one embodiment, the pay plan maintenance module 102c comprises a system and method for allowing employers to distribute bonuses to employees.

The embodiments described in this specification differ from and improve upon existing plan systems. In particular, 401a Matching Plans that exist in the plan systems for schools today are highly influenced by the corporate Retirement Plan, 401k. However, the pressure on schools to use 401a Matching Plans in ways similar to corporate 401k plans amounts to undue influence because teachers are generally very happy with their own Teacher Retirement Systems and teachers are very unhappy with their sense of not being adequately compensated. In addition, when teachers' 401a Plans are used as retirement plans they don't work well at all because the investment options offered are highly inappropriate for their current financial needs.

In contrast, the risk management and compensation improvement system in some embodiments includes an employee matching program based on a newly designed 401a Plan in which teachers make qualifying contributions to the 401a Plan in order to receive the Employers' powerfully effective matching contribution. Additionally, the employee matching program provides teachers a wide range of investment options in which to choose to make qualifying contributions. Moreover, in some embodiments, the investment options that are offered are those most appropriate for the various stages in the financial life of a teacher's family.

By way of example, FIGS. 2A, 2B, and 2C illustrate progressively increasing details of the current plan module 102a. In FIG. 2A, one or more user inputs 201 are fed to the input module 101, and then stored in the user input data repository 202. In some embodiments, the risk management and compensation improvement system 100 comprises user inputs 201 and user input data 202. In some embodiments, the risk management and compensation improvement method receives one or more user inputs 201 at the input module 101 of the system. The method of some embodiments receives the user inputs 201 based on information entered (or data input) by a user or an agent on behalf of the user. The information entered by the user is typically input via a standard computer input device, such as a mouse or keyboard, and pertains to at least one risk management and compensation improvement desire of the user. After the user enters the information, the method of some embodiments collects the user input data 201 at the system input module 101 and stores the user inputs 201 in the user input data repository 202.

By using the risk management and compensation improvement method in this way, a teacher is able to outline one or more financial goals that relate directly to the financial life of his or her family. Examples of using the risk management and compensation improvement system to attain specific financial goals include, without limitation, (i) employees using their funds to get out of debt, (ii) employees using their funds to build a savings plan for more current or immediate needs, (iii) employees using their funds to build a savings plan for longer term goals (e.g., saving fora child's college tuition and other financial needs, saving to buy another home, or saving for weddings, etc.), (iv) employees who would like to shelter some of their income from current taxation, and (v) employees who simply wish to maximize income by taking advantage of the employer's allocation of the Employer's Matching contribution. These five examples illustrate the current savings and investments needs of every participant in the Schools 401a Plan.

While employee contributions form the backbone of the 401a Plan, it is of utmost importance that the risk management and compensation improvement system implement the Plan in a way that meets the current savings and investment needs of every participating employee. Since such needs are often in a state of change, employers need to be diligent in reviewing the Plan on a regular basis, especially as individuals and families change.

In some embodiments, the user inputs 201 comprise employee background 203 information, added payroll cost 204 information, and take home deductions 205. This is shown in FIG. 2B, which illustrates the employee background 203 input, the added payroll costs 204, and take home deductions 205. As shown in this figure, the employee background information 203, the added payroll cost data 204, and the take home deductions 205 are shown flowing into the input module 101, and thereafter stored in the user input data repository 202.

By way of example, FIG. 2C illustrates several user inputs, 203a-d, 204a-e, and 205a-d, which flow into input module 101. Specifically, in some embodiments of the risk management and compensation improvement system, the employee background 203 information includes a base salary 203a, an average annual raise rate 203b, an age 203c, and a target retirement age 203d. In some embodiments, the data for the added payroll costs 204 includes a pension rate employer portion 204a, social security paid by employer 204b, Medicare rates 204c, worker's comp expenses 204d, and unemployment insurance 204e. In some embodiments, the take home deductions 205 comprise federal taxes 205a, state taxes 205b, a pension rate employee portion 2050, and social security paid by the employee 205d.

The example user inputs 201 as shown in FIG. 2B (i.e., employee background 203, added payroll costs 204, and take home deductions 205) and FIG. 2C are exemplary and should not be construed as exhaustive. For example, user inputs 201 can further comprise a retirement date, a minimum retirement income amount, a gender of said user, or similar such information. It is understood that user inputs 201 can comprise different variables for various employee types and various employers.

FIG. 3 conceptually illustrates an example of a computer display with a graphical user interface (GUI) for receiving user inputs for an input module in some embodiments. The input module 101 of some embodiments includes a program for collecting the user inputs 201. In at least one embodiment, the input module 101 may be represented in the GUI 301 shown on the computer display. In at least one embodiment, the GUI 301 on the computer display comprises a graphical display screen of a software program or a web page. In at least one embodiment, the graphical display can be printed (i.e., to paper, electronically to a portable document format, such as PDF, etc.). In at least one embodiment, the employee background 203, the added payroll costs 204, and take home deductions 205 can be typed into a computer (i.e., by way of a keyboard device communicably connected to the computer) and displayed in the GUI 301 shown on the computer display. In some other embodiments, the user inputs 201 can be entered by other input devices. For example, by using a mouse pointing device, at least some of the user inputs 201 may be selected from one or more of a menu tool displayed in the GUI 301, a pull-down list tool adjacent to a user input 201 field with a set of values to select from for the user input 201 field, a set of selectable and draggable icons which when moved by the mouse can be dropped into a particular user input 201 field (e.g., a federal tax bracket), etc. In some other embodiments, a microphone device can be configured to operate with a set of a software programs that receive and process voice commands of a user. Regardless of the manner in which the user inputs 201 are provided, once they are entered (i.e., by typing on the keyboard, selecting by mouse, or dictating by voice command), users can select (i.e., by using a mouse, track pad, or touch display device) a submit button 302 to enter the user inputs 201 into risk management and compensation improvement system 100.

FIG. 4 conceptually illustrates a process performed by a pay plan module of a risk management and compensation improvement system in some embodiments. The pay plan module 102a process begins by retrieving the user input data stored in the repository 202. The pay plan module 102a process then calculates (at 401) the value of an annual raise with all costs added and income deducted. The process performed by the pay plan module 102a outputs the annual cost (at 402) of the pay raise to the employer and outputs the annual value (at 403) of the pay raise to the employee. In some embodiments, the pay plan module 102a automatically outputs the employer's annual cost and the employee's annual value. Example formatted output tables for the employer's annual cost and the employee's annual value are described below, by reference to FIGS. 5 and 6, respectively.

In some embodiments, the process then displays (at 404) a cost vs. benefit table based on outputs for the employer's annual cost and the employee's annual value. An example of a cost vs. benefit table is described below, by reference to FIG. 7. In some embodiments, the process displays (at 405) a cost vs. benefit chart instead of or in addition to the cost vs. benefit table. In some embodiments, the user may configure the process to display either the table or the chart, or both, if preferred. Examples of cost vs. benefit charts 405a and 405b are described below, by reference to FIG. 8. The cost/benefit table and chart and the associated calculated values of each are then stored by the pay plan module 102a process in the calculation output data repository 406. From this repository 406, the pay plan module 102a process is able to retrieve the value and cost data, which the process uses to provide a summary calculation (at 407). The pay plan module 102a process then displays (at 408) the summary calculation for the benefit of the user. An example of a summary calculation display is described below, by reference to FIG. 9.

As noted above, the process performed by the pay plan module 102a calculates the annual cost to the employer. By way of example, FIG. 5 conceptually illustrates a computer display of a table that includes cost to employer calculations in some embodiments. In some embodiments, cost to employer calculation 402 comprises a year number 501, an annual salary 502, one or more employer payroll expenses 503, and an employer cost of raise 504. In some embodiments, the year number 501 comprises a set of integers between zero and a final year calculated 505. In some embodiments, the final year calculated 505 comprises the difference between target retirement age 203d and age 203e. In some embodiments, the final year calculated 505 comprises the number of years of annual raises to increase an employee's take home pay by an amount equal to annual raise 503f divided by 12; i.e., final year calculated 505 is the year in which an employee's pay actually reaches the claimed increase, thereby illustrating the effect of payroll costs 204 and home deductions 205 on raises.

In some embodiments, employer payroll expenses 503 comprise pension costs 503a, social security costs 503b, Medicare costs 503c, workers comp costs 503d, unemployment insurance costs 503e, and an annual raise 503f. In some embodiments, a district may not be required to pay into social security costs 503b but may be required to pay into Medicare costs 503c. For purposes of this disclosure it is not critical to disclose every law pertinent to payroll taxes; rather, it is critical to demonstrate that risk management and compensation improvement system and method 100 is capable of accommodating a variety of tax law to accomplish its purposes. In some embodiments, determining annual salary 502 for each of the years 501 comprises multiplying a previous annual salary 502 by the sum of one (1) and an average annual raise rate 203b. In some embodiments, determining the annual raise 503f comprises subtracting a current annual salary 502 from a previous annual salary 502. In some embodiments, calculating each of 503a-503e comprises multiplying each respective annual raise 503f by 204a-204e, respectively. In some embodiments, calculating the employer cost of raise 504 comprises calculating the sum of 503a-503f. In some embodiments, a total employer cost of raises 506 comprises a total cost of raises for an employee from a current time through the final year calculated 505. In some embodiments, determining total employer cost of raises 506 comprises calculating the sum of employer cost of raise 504 from each of year 1 through final year calculated 505.

As noted above, the process performed by the pay plan module 102a calculates the annual value of the raise to the employee. By way of example, FIG. 6 conceptually illustrates a computer display of a table that includes value of raise calculations in some embodiments. Value of raise calculation 403 comprises years 501, annual salary 502, annual raise 503f, one or more annual take home deductions 601, a net annual take home increase 602, and a total net annual take home increases 603. In some embodiments, annual take home deductions 601 comprises a federal income tax deduction 601a, a state income tax deduction 601b, a pension deduction 601c, and social security and Medicare deduction 601d. In some embodiments, calculating each annual take home deductions 601 (e.g., 601a-601d) for each of the years 501 comprises multiplying negative one (−1) by annual raise 503f by respective take home deductions 205 (205a-205d). In some embodiments, calculating net annual take home increase 602 for each of the years 501 comprises adding annual raise 503f to the sum of each annual take home deduction 601 for each of the years 501, respectively. In some embodiments, calculating total net annual take home increases 603 comprises adding all net annual take home increase 602 for each of the years 501.

The pay plan module 102a process may, depending on the configuration settings for viewing cost vs. benefit data, provide a cost vs. benefit table 404 for review. By way of example, FIG. 7 conceptually illustrates a computer display of a cost vs. benefit table 404 in some embodiments. As shown in this figure, the cost vs. benefit table 404 comprises years 501, annual base salary 502, annual raise 503f, employer cost of raise 504, total employer cost of raises 506, net annual take home increase 602, total net annual take home increases 603, and net monthly take home increase 701. In some embodiments, calculating net monthly take home increase 701 comprises dividing net annual take home increase 602 by twelve (12) for each of years 501. Benefit table 404 comprises a claimed annual raise 702, an actual annual take home equivalent 703 and an actual employer cost 704. In some embodiments, claimed annual raise 702 comprises annual raise 503f in a first year 501a; wherein, claimed annual raise 702 can represent an amount an employer ostensibly raises an employee's income. In some embodiments, actual annual take home equivalent 703 comprises home increase 602 in an actual year 501b; wherein actual year 501b represents years 501 in which home increase 602 is equal to or more than claimed annual raise 702. Further, in some embodiments, actual employer cost 704 comprises the raise 504 in actual year 501b. In some embodiments, demonstrating inefficiency of an old fashioned pay plan comprises: analyzing claimed annual raise 702, actual annual take home equivalent 703 and actual employer cost 704; showing employees that claimed annual raise 702 does not become actual annual take home equivalent 703 until actual year 501b; showing employers that it costs actual employer cost 704 to give actual annual take home equivalent 703; analyzing how employee morale is seldom improved by mere annual increases of average annual raise rate 2031; and, asserting that the high cost and low return for both employer and employee needs to be improved.

As described above, the process performed by the pay plan module 102a may provide a cost vs. benefit chart 405 for review. By way of example, FIG. 8 conceptually illustrates a computer display of a cost vs. benefit chart in some embodiments. Cost vs. benefit chart 405 comprises a first chart 405a and a second chart 405b on computer display 301 displaying a portion of benefit table 404 as line charts. In some embodiments, benefit chart 405 comprises line charts displaying a dollars 801 (y-axis) over years 501 (x-axis). In some embodiments, first chart 405a comprises displaying three x-axis values (comprising annual raise 503f, raise 504, and home increase 602) overlaid on the same chart. In some embodiments, first chart 405a comprises a display of an “Annual Trend: Cost of a Raise vs. Annual Benefit to an Employee”. In some embodiments, said demonstrating inefficiency of an old fashioned pay plan comprises comprises displaying first chart 405a to establish how much an employer must pay with such limited return to employees year after year. In some embodiments, second chart 405b comprises home increase 701 plotted as a line chart. In some embodiments, second chart 405b comprises a display of an “Annual Trend: Monthly Take Home Increase”. In some embodiments, said demonstrating inefficiency of an old fashioned pay plan comprises showing how slowly an employee's monthly take home pay increases over a period of the employee's career.

As noted above, the pay plan module 102a process concludes with a summary calculation display for review. By way of example, FIG. 9 conceptually illustrates a computer display of a pay plan summary in some embodiments. In some embodiments, summary display 408 comprises results from an analysis by summary calculation 407. In some embodiments, summary display 408 comprises a first monthly raise 901, a first monthly expenses 902, and a first monthly take home 903. First monthly raise 901 comprises claimed annual raise 702 in first year 501a divided by twelve (12) so as to establish a monthly raise value in first year 501a. In some embodiments, first monthly expenses 902 comprises raise 504 divided by twelve (12) in first year 501a. In some embodiments, first monthly take home 903 comprises home increase 701 in first year 501a. In some embodiments, said demonstrating inefficiency of an old fashioned pay plan comprises summarizing an analysis of calculation outputs 406. For example, in some embodiments, summary display 408 comprises: stating first monthly raise 901 resulting from a portion of employee background 203; stating that an employer's pay roll costs and actual cost for a raise are first monthly expenses 902; showing that employees benefit is much lower than intended by stating first monthly take home 903; and summarizing that the employer is paying too much and the employee is waiting too long with total employer cost of raises 506, actual year 501b, and first monthly raise 901. Summary display 408 can illustrate the need for creative thinking since pay raises alone do not create a sufficient basis for employee morale improvement. In some embodiments, summary display 408 can further comprise one or more demonstration variables 904. In some embodiments, demonstration variables 904 comprises data intending to be used to demonstrate an improved pay plan. In some embodiments, demonstration variables 904 comprises average annual raise rate 203b converted into an annual matching plan sum 904a. In some embodiments, annual matching plan stun 904a comprises an employee contribution 904b plus an employer match 904c. For purposes of illustration, employee contribution 904b will equal 1% and employer match 904c will equal 2% in FIG. 9 and following.

FIG. 10 conceptually illustrates a process for calculating and displaying plan value accumulation in a pay plan implementation of some embodiments. As shown in this figure, the pay plan implementation module 102b comprises an annual accumulation calculation 1001 and an accumulation display 1002 (e.g., a table or a chart).

FIG. 11 conceptually illustrates a computer display of a plan value accumulation table 1002. In some embodiments, accumulation table 1002 comprises a table for demonstrating an effect of converting a single annual raise 503f in actual year 501b into annual matching plan sum 904a over a plurality of years 501. In some embodiments, accumulation table 1002 comprises years 501, base salary 203a, an annual contribution 1101, an accumulation subtotal 1102, an annual investment earnings 1103, an accumulation total 1104, and an interest earned 1105. In some embodiments, risk management and compensation improvement system and method 100 comprises improving compensation by converting a single annual raise 503f into annual matching plan sum 904a. In some embodiments, said conversion comprises skipping annual raise 503f in first year 501a an instead investing annual matching plan sum 904a into an investment account bearing annual investment earnings 1103. In some embodiments, accumulation subtotal 1102 in a given year comprises a sum of accumulation total 1104 for the year prior plus annual contribution 1101 for the current year. In some embodiments, annual investment earnings 1103 for a given year comprises interest earned by said investment account comprising of a principal amount equal to accumulation subtotal 1102. For illustrative purposes, annual investment earnings 1103 is equal to a product of accumulation subtotal 1102 times a fixed percentage (3% in this case); using a fixed percentage is for illustrative purposes only and does not necessarily represent real world conditions for investment accounts in general or said investment account specifically. In some embodiments, accumulation total 1104 in a given year comprises a sum of accumulation subtotal 1102 plus annual investment earnings 1103. In some embodiments, interest earned 1105 comprises a sum of annual investment earnings 1103 for all years represented in accumulation table 1002. In some embodiments, improving compensation comprises improving an employee's long term financial positron by converting a single average annual raise rate 203b into annual matching plan sum 904a. In another embodiment, risk management and compensation improvement system and method 100 comprises improving employee morale by converting a single annual raise 503f into annual matching plan stun 904a and illustrating the value of said conversion ahead of time. In some other embodiments, the risk management and compensation improvement system and method 100 comprises improving employee morale by illustrating progress in said conversion.

FIG. 12A conceptually illustrates a computer display of an example report card 1200a for a pay plan. As shown in this figure, the report card 1200a is displayed at approximately month 39 since plan implementation. In some embodiments, the risk management and compensation improvement system and method 100 comprises a report card 1200 having a plurality of updated versions such as report card 1200a and a report card 1200b. In some embodiments, report card 1200 comprises a portion of morale boosting module 102c, which is described above by reference to FIG. 1B. In some embodiments, report card 1200 comprises a progress summary for each individual employee using risk management and compensation improvement system and method 100. hr one embodiment, report card 1200 comprises a printed report issued with each paycheck. In another embodiment, report card 1200 comprises a display on computer display 301. In some embodiments, report card 1200 comprises statistics demonstrating an employee's current income calculations, accumulation total 1104, and a graphic for showing financial progress. In some embodiments, report card 1200 comprises statistics for a particular month or pay period under risk management and compensation improvement system and method 100, designated by the period of time since the start of the program, or a plan year 1201 and plan month 1202. In some embodiments, plan month 1202 comprises the sum total of months since the beginning of risk management and compensation improvement system and method 100 for an employee. In some embodiments, report card 1200 comprises base salary 203a during plan year 1201. In some embodiments, report card 1200 can calculate a savings status comprising a current savings total 1203, a current earnings 1204, an employee contribution 1205, an employer contribution 1206, and accumulation total 1104. In some embodiments, current savings total 1203 comprises a total accumulation total 1104 in the pay period preceding plan month 1202. In some embodiments, current earnings 1204 comprises annual investment earnings 1103 for plan month 1202 (rather than for an entire year). In some embodiments, employee contribution 1205 and employer contribution 1206 comprises contributions corresponding to employee contribution 904b and employer match 904e, respectively. In some embodiments, accumulation total 1104 on report card 1200 comprises a sum of 1203-1206 rendering a revised total for said improved pay plan. In some embodiments, report card 1200 can calculate current income using a current gross income 1207, a current deductions 1208, a savings contribution deduction 1209, and a current net income 1210. In some embodiments, current gross income 1207 comprises base salary 203a divided by twelve (12), where a current pay period is equal to one month. In some embodiments, current deductions 1208 comprises a sum of all deductions and withheld fees and expenses from current gross income 1207. In some embodiments, savings contribution deduction 1209 comprises the negative product of current gross income 1207 times employee contribution 904b; wherein, savings contribution deduction 1209 comprises the amount said employee contributes toward accumulation total 1104 (the absolute value of which equals employee contribution 1205). In some embodiments, current net income 1210 comprises a sum of 1207-1209; wherein, current net income 1210 comprises said employee's take home income for plan month 1202 or current pay period. In some embodiments, report card 1200 can further comprise an accumulated pay plan value 1211. In some embodiments, accumulated pay plan value 1211 comprises a line chart comprising a plotted chart comprising accumulation total 1104 values from month one (1) through plan month 1202 (a current month). In some embodiments, risk management and compensation improvement system and method 100 comprises improving morale by showing increasing accumulation total 1104 over time.

In some embodiments, report card 1200 can further comprise a financial home indicator 1212. In some embodiments, financial home indicator 1212 comprises a graphic for showing financial progress and improving employee morale. In some embodiments, financial home indicator 1212 comprises a user indicator 1213, a foundational floor 1214, a first floor 1215, and a second floor 1216. In some embodiments, risk management and compensation improvement system and method 100 comprises: developing an employee investment plan according to each employee's current financial circumstance; establishing an employee's current stage in said employee investment plan; setting goals for said employee; and reassessing said employee's current stage incrementally. In some embodiments, financial home indicator 1212 comprises an illustration of said user's financial health. In another embodiment, financial home indicator 1212 comprises a path to financial health for said user. In some embodiments, financial home indicator 1212 comprises a three-stage process; wherein said three-stage process is used to craft a financial plan for a user as life stages change and thereby deal with the risk of not having needed funds at a critical time. In some embodiments, financial home indicator 1212 can visualize said three-stage process as a home with three floors. However, it is understood that the use of “floors” is illustrative only all references to floors could be replaced with a reference to a stage or procedural step. In some embodiments, user indicator 1213 is illustrated on foundational floor 1214 where said employee is accomplishing foundational financial tasks such as paying down debt and/or building up an emergency savings fund. In some embodiments, foundational floor 1214 comprises a utilization step, wherein said user can focus on paying for fundamental needs and/or eliminating consumer debt. While said user is classified in foundational floor 1214 they are likely to need all financial resource to pay for their overhead. Examples of overhead or fundamental needs include but are not limited to: getting out of debt, saving for an emergency fund, and/or saving for a long term savings plan for future needs. In some embodiments, said employer could limit those uses to which said employee can use funds. In some embodiments, a bridge step from foundational floor 1214 to first floor 1215 comprises a non-qualified annuity or other financial instrument. In some embodiments. said non-qualified annuity comprises a program wherein deposits are not taxed and grow tax sheltered; further, in some circumstances a portion of said non-qualified annuity could be withdrawn tax free and thereby limit risk that said employee would not have funds needed. In some embodiments, second floor 1216 comprises an accumulation step for said user. In some embodiments, said accumulation step comprises investments in the stock market or similar. In some embodiments, calculating a position for user indicator 1213 comprises: assessing risks for said user, determining risk tolerances, assessing said user's position relative to said risk tolerances, and placing said user in a user stage. In some embodiments, said user stage comprises one of foundational floor 1214, first floor 1215, or second floor 1216 based upon user stage calculation 1202. In some embodiments, user indicator 1304 can be placed within financial home indicator 1212 by correlating user indicator 1304 with said user stage.

FIG. 12B conceptually illustrates a computer display of another example report card 1200b for a pay plan. As shown in this figure, the report card 1200b is displayed at approximately month 203 since plan implementation. In some embodiments, user indicator 1213 can progress from foundational floor 1214 to first floor 1215 where accumulation total 1104 reaches a first threshold 1217. For example, in FIG. 12B, where plan month 1202 is month number two hundred three (203), accumulation total 1104 is $30,220.14 and first threshold 1217 is $15,000.00; since accumulation total 1104 is greater than first threshold 1217, user indicator 1213 has progressed to first floor 1215.

FIGS. 13A, 13B, 13C, and 13D conceptually illustrate a method for risk management and compensation improvement in some embodiments. In some embodiments, risk management and compensation improvement system 100 performs the method for risk management and compensation improvement 1300 described by reference to these figures. Referring to FIG. 13A, the method 1300 starts by establishing (at 1301) that an old fashioned pay plan is ineffective. As noted above, the current problems that exist with compensation systems in general, and those specifically intended for teacher compensation, typically involve pay inadequacy. Furthermore, the intentions of some schools to force fit 401a Plans into methods that are functionally equivalent to 401k plans are ill informed solutions that disregard the different financial goals that many teachers have. Thus, understanding that a currently implemented (old fashioned) plan is not working in the way it is intended to work is the first step in providing a plan with adequate risk management and compensation improvement for all plan participants.

Next, the method illustrates (at 1302) the effect of converting a single annual raise into an annual matching plan contribution. As each employee has different financial goals and constraints, the process transitions to step for staging investments (at 1303) according to an employee's specific needs. The method 1300 then performs investment analysis, generates comparison charts and tables, and creates reports (at 1304) in an effort to improve employee morale. As laid out in great detail above, pay plan report cards provide a critical means of improving the morale of employees who are able to see future predicted values of the investment accounts chosen. Also, because these plans are able to provide a wide range investment options, almost all investment goals can be satisfied when the plan is implemented.

Referring to FIG. 13B, when the method 1300 establishes that an existing old fashioned plan is ineffective, the method 1301 starts by analyzing a particular claimed amount of an annual raise, an actual take-home equivalent (after costs are deducted, such as social security, state taxes, federal taxes, etc.), and the actual employer cost of the raise (taking into account the employer's added costs). Then the method 1301 performs a step for showing that actual employer cost does not become the actual take-home equivalent until a particular year. Following this, the method 1301 demonstrates to employers that their actual costs to provide an actual annual take-home equivalent is much higher than the raise. The method 1301 further analyzes morale amongst employees who are participants in the existing old fashioned pay plan. This step can be performed at a different time during the method 1301 or continuously throughout the entire process in which the method 1301 performs various operations and functions in establishing whether the existing old fashioned pay plan is ineffective. Regardless of when performed, once there is an established pattern of low morale amongst the plan participants, the method then asserts that the high costs and low returns for both plan participants and employers needs to be changed.

Referring to FIG. 13C, when the method 1300 illustrates the effect of converting a single annual raise into an annual matching plan, the method 1302 starts the demonstration by skipping an annual raise in a first exemplary year. The method 1302 then invests an equal amount into a matching plan held in an investment account bearing investment earnings. This demonstration is a persuasive element, but vital in preparing for a plan conversion that is well accepted by current and future plan participants.

Referring to FIG. 13D, when the method 1300 improves employee morale with pay plan report cards, the method 1304 starts the developing an employee investment plan according to current expected financial circumstances. Then the method 1304 determines what the employee's current stage is in the investment plan. The method 1304 follows this by setting and/or suggesting one or more financial goals for the employee. In the first instance of the method 1304 performing these steps, it is likely that the employee's morale about the pay plan may improve. However, the method 1304 reassesses the employee's financial stage incrementally in order to keep the employee's financial plans on track and to ensure that the employee's morale improves and/or remains at a high level during the entire during of the employee's participation in the pay plan. This is critical for success of the pay plan since this money will not be available to the employee until their termination of employment. Therefore, it is of utmost importance that this money be managed in the most fiduciarily responsible manner.

To combine use the risk management and compensation improvement system and method of the present disclosure, an employer should have a 401a Plan Document adopted with the help of an attorney. Various Pension Services Firms have Plan Documents available—and they can be amended as needed with the help of an attorney. One fundamental requirement is that money be managed in the most fiduciarily responsible manner. For instance, in keeping with the fiduciary responsibility, the employer could select three different sets of appropriate investment vehicles to offer plan participants. One set of investments would be for those types of savings and investments described by reference to some of the figures. A second set of investments would be for safe, secure and highly rated annuity savings accounts (for they are insured). A third set of investments must be chosen for those desiring to invest something in the market. This type of investment must be a Total Market Index Fund. It will perform exactly as the total market performs, no more no less. By way of example, the employer could combine a Portfolio of Index Funds which cover the entire U.S. Economy, and couple it with an offering of U.S. Government Insured Savings Plans, such as Fixed Annuity products. The plan participant would then be able to choose the percentages in each pool. Nobel Prize winner Harry Markowitz once referred to this investment strategy as attaining “The Super-Efficient Frontier”. The employee and/or employer pay no commissions—only a service fee. These three different investments would be available for use whether it be the employee's contribution—or the employer's contributions as selected by the employee.

However, since this fiduciarily correct investment strategy is only a reflection of the entire U.S. economy, it is not fail proof. To be totally fiduciarily correct, the employer (now less concerned about such “indicators” as moves in the market, interest rates, or employment numbers) must now be concerned with more major fiduciary responsibilities (i.e., the leading market indicators as reflected by Congressional Actions or the lack thereof).

A fiduciarily correct employer ought to be assured that regulations now in place are those regulations needed to assure that our economy is protected; and, so regulated that it will continue as dynamic system of checks and balances. These checks and balances must equally protect each U.S. Citizen's role in our economy, whether a major investor, a company owner, a small investor, an employee, or a consumer. While being aspirational goals, employers with this fiduciary duty (to provide a set of fiduciarily sound investment options and strategies) are at least one group in position to uphold such sound principals. Taken to one extent, any new rule, law, or regulation that takes anything from the rights of any one of these five groups of citizen participants (i.e., major investors, company owners, small investors, employees, and consumers) so that another group can profit should be publicly announced and understood because left unchanged it will eventually have serious and adverse effects upon our nation's economy—and thus damage the employee's “Fiduciarily Correct” investment strategy. In other words, it robs those who have nothing to gain from our economy except what they can gain from the application of their own personal free, enterprising spirit!

However, as noted above regarding the problems that many teachers and educators have with their own pay plans, a number of problems exist on a broad national scale which has an impact on every pay plan, work agreement, welfare, and general livelihood, whether seen or presently unseen. At least three of these problems expressed here, namely, (i) Congress has been known to actually repeal certain long-standing and necessary regulations that maintain a solid footing in the U.S. economy overall, notably, Congressional repeal of the Glass Steagall Act, which has not been re-instated, (ii) Congress has been known to actually ignore and not enforce other long-standing and necessary regulations such as Sherman Anti-Tust Act which was to be overseen by the Federal Trade Commission, resulting in approximately 35-40 viable, active insurance companies today compared to over 7,000 effectively competing insurance companies 20 years ago and is still not being enforced, and (iii) Congress has been known to actually adopt new laws which are totally contrary to our U.S. economy—laws which serve only a small segment of our total economy (an example of such self-serving regulations is the North American Free Trade Act (NAFTA)—in which imported manufactured goods are shipped to the United States with no import fees, causing jobs to move overseas, and then products are manufactured with cheap labor and shipped back to the U.S. with no Tariff, and sold to U.S. consumers at their old regularly prices, resulting in soaring unemployment rate while corporate profits sky-rocket.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention.

Also, many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

FIG. 14 conceptually illustrates an electronic system 1400 with which some embodiments of the invention are implemented. The electronic system 1400 may be a computer, phone, PDA, or any other sort of electronic device. Such an electronic system includes various types of computer readable media and interfaces for various other types of computer readable media. Electronic system 1400 includes a bus 1405, processing unit(s) 1410, a system memory 1415, a read-only 1420, a permanent storage device 1425, input devices 1430, output devices 1435, and a network 1440.

The bus 1405 collectively represents all system, peripheral, and chipset buses that communicatively connect the numerous internal devices of the electronic system 1400. For instance, the bus 1405 communicatively connects the processing unit(s) 1410 with the read-only 1420, the system memory 1415, and the permanent storage device 1425.

From these various memory units, the processing unit(s) 1410 retrieves instructions to execute and data to process in order to execute the processes of the invention. The processing unit(s) may be a single processor or a multi-core processor in different embodiments.

The read-only-memory (ROM) 1420 stores static data and instructions that are needed by the processing unit(s) 1410 and other modules of the electronic system. The permanent storage device 1425, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive) as the permanent storage device 1425.

Other embodiments use a removable storage device (such as a floppy disk or a flash drive) as the permanent storage device 1425. Like the permanent storage device 1425, the system memory 1415 is a read-and-write memory device. However, unlike storage device 1425, the system memory 1415 is a volatile read-and-write memory, such as a random access memory. The system memory 1415 stores some of the instructions and data that the processor needs at runtime. In some embodiments, the invention's processes are stored in the system memory 1415, the permanent storage device 1425, and/or the read-only 1420. For example, the various memory units include instructions for processing appearance alterations of displayable characters in accordance with some embodiments. From these various memory units, the processing unit(s) 1410 retrieves instructions to execute and data to process in order to execute the processes of some embodiments.

The bus 1405 also connects to the input and output devices 1430 and 1435. The input devices enable the user to communicate information and select commands to the electronic system. The input devices 1430 include alphanumeric keyboards and pointing devices (also called “cursor control devices”). The output devices 1435 display images generated by the electronic system 1400. The output devices 1435 include printers and display devices, such as cathode ray tubes (CRT) or liquid crystal displays (LCD). Some embodiments include devices such as a touchscreen that functions as both input and output devices.

Finally, as shown in FIG. 14, bus 1405 also couples electronic system 1400 to a network 1440 through a network adapter (not shown). In this manner, the computer can be a part of a network of computers (such as a local area network (“LAN”), a wide area network (“WAN”), or an intranet), or a network of networks (such as the Internet). Any or all components of electronic system 1400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 4, 10, and 13A-13D conceptually illustrate processes. The specific operations of these processes may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device manages investment risk and improves compensation for an employee, said program comprising sets of instructions for:
receiving an amount of money designated for a single annual pay raise of an employee;
converting the money designated for the single annual pay raise of the employee into a monetary contribution into an investment plan sponsored by the employer; and
investing the monetary contribution in a set of investment options offered through the investment plan.

2. The non-transitory computer readable medium of claim 1, wherein the investment plan is a matching contribution plan.

3. The non-transitory computer readable medium of claim 2, wherein the employer is obligated to contribute an amount equal to the monetary contribution into the matching contribution plan for the benefit of the employee.

4. The non-transitory computer readable medium of claim 1, wherein the program further comprises a set of instructions for generating a report card of the investment plan to improve employee morale.

5. The non-transitory computer readable medium of claim 1, wherein the program further comprises a set of instructions for generating a comparison table that charts a set of values representing the money designated for the single annual pay raise in comparison with a set of values representing the monetary contribution.

6. A method of converting an existing pay plan system into a risk management and compensation improvement pay plan system, the method comprising:
determining whether the existing pay plan system is ineffective;
demonstrating the effect of converting a single annual pay raise into an annual contribution in an employer matching pay plan;
creating a set of investment plan accounts corresponding to a set of employees, wherein each investment plan is tailored to a set of specific needs of the corresponding employee;
analyzing current and future predicted values of investments held in the set of investment plan accounts; and
generating report cards for the employer matching pay plan to improve employee morale, wherein the report cards comprise investment performance data of the investments held in the set of investment plan accounts.

7. The method of claim 6, wherein demonstrating the effect of converting comprises:
foregoing an annual pay raise in a first employer matching pay plan year, wherein the annual pay raise comprises a specific monetary amount;
depositing an amount of money that is equal to the specific monetary amount into the employer matching pay plan; and
investing the deposited amount of money in investments bearing investment earnings.

8. A risk management and employee compensation system that mitigates risk and improves employee morale, said system comprising:
an input module that receives a set of user inputs comprising background information of an employee, a set of payroll add-on costs, and a set of take home deductions;
a user input data repository that stores a set of user input data received from the input module after the input module receives the set of user inputs;
a pay plan module that retrieves a particular set of stored user input data associated with an employee and calculates a value associated with an annual pay raise amount; and
an employer matching pay plan maintenance module that generates (i) a first set of formatted output data associated with the annual cost of the pay raise to the employer, (ii) a second set of formatted output data associated with the annual benefit value of the pay raise to the employee, and (iii) a third set of formatted output data associated with a cost-benefit analysis based on the employer cost and the employee benefit value.

9. The risk management and employee compensation system of claim 8 further comprising a calculation output data repository, wherein the employer matching pay plan maintenance module stores each of the first set of output data, the second set of output data, and the third set of output data in the calculation output data repository.

10. The risk management and employee compensation system of claim 9, wherein the employer matching pay plan maintenance module (i) retrieves each of the first set of output data, the second set of output data, and the third set of output data from the calculation output data repository and (ii) performs a set of calculations that summarize each set of retrieved data.

11. The risk management and employee compensation system of claim 10, wherein the employer matching pay plan maintenance module displays a summary of the cost-benefit analysis of the pay raise based on the summarized set of retrieved data.
